(19) United States
(12) Patent Application Publication
(10) Pub. No.: US 2009/0138511 A1
(43) Pub. Date: May 28, 2009

(54) Service access exception tracking for regulatory compliance of business processes

(75) Inventors: Lyle Strub, Ottawa (CA); Laura Serghi, Ottawa (CA); Piragash Velummylum, Seattle, WA (US)

Correspondence Address: KRAMER & AMADO, P.C., 1725 DUKE STREET, SUITE 240, ALEXANDRIA, VA, 22314, US

(73) Assignee: ALCATEL LUCENT, Paris (FR)

(21) Appl. No.: 11/987,172

(22) Filed: Nov. 28, 2007

(51) Int. Cl. G06F 13/00; G06F 17/00; G06F 9/44

(52) U.S. Cl. 707/104.1; 719/313; 707/E17.009

(57) ABSTRACT

A system for service access exception tracking and related method including an exception detection engine that receives a web services request message, the web services request message associated with at least one web service and a controller that sends a script to the exception detection engine, the script comprising a set of rules for the at least one web service. In various exemplary embodiments, the exception detection engine detects at least one exception in the web services request message by applying the set of rules and drops the web services request message. In various exemplary embodiments, a method of implementing a control path for a controller in a system for web service access exception tracking includes one of more of the following: downloading a script, the script comprising a set of rules for at least one web service; sending the script to an exception detection engine; detecting at least one exception type with the exception detection engine by applying the set of rules to a web services request message; receiving the at least one exception type from the exception detection engine; and storing the at least one exception type in an exceptions database.

### BACKGROUND OF THE INVENTION

1. Field of the Invention

This invention relates generally to detecting exceptions to expected business practices.

2. Description of Related Art

There is a need for an application that automatically detects and prevents business process exceptions as they occur, without the need for manual tasks or custom software development. Moreover, there is a need for an automated solution for monitoring access and alterations to corporate services and data that takes a configurable action based on the type and severity of the exception.

The foregoing objects and advantages of the invention are illustrative of those that can be achieved by the various exemplary embodiments and are not intended to be exhaustive or limiting of the possible advantages which can be realized. Thus, these and other objects and advantages of the various exemplary embodiments will be apparent from the description herein or can be learned from practicing the various exemplary embodiments, both as embodied herein or as modified in view of any variation which may be apparent to those skilled in the art. Accordingly, the present invention resides in the novel methods, arrangements, combinations and improvements herein shown and described in various exemplary embodiments.

### SUMMARY OF THE INVENTION

In the wake of recent corporate scandals in the United States, modern corporations have faced increased public and governmental scrutiny. Congress has passed a number of regulations, such as the Sarbanes-Oxley Act, that set forth stringent requirements for corporations, including a number of rules designed to prevent misuse of corporate data and IT systems. A corporation's failure to comply with these regulations could result in loss of confidence by investors, lawsuits, regulatory fines, and even bankruptcy.

Given the importance of these regulations, corporations spend significant amounts of time and money to ensure compliance. A number of well-known auditing firms perform manual compliance audits to solve corporate reporting problems. These manual audits, however, suffer from a number of deficiencies. The manual audit is only effective in detecting problems that have already occurred, not in detecting problems before they occur. Moreover, because the manual audits are performed by employees of the auditing firm, there remains a risk of human error resulting in the failure to detect a problem. In addition, the corporation bears all costs of the audits, which are often time consuming and costly.

In light of the present need for service access exception tracking for regulatory compliance of business processes, a brief summary of various exemplary embodiments is presented. Some simplifications and omission may be made in the following summary, which is intended to highlight and introduce some aspects of the various exemplary embodiments, but not to limit its scope. Detailed descriptions of a preferred exemplary embodiment adequate to allow those of ordinary skill in the art to make and use the invention concepts will follow in later sections.

Various exemplary embodiments include customized software solutions tailored to the corporation's data infrastructure. Such embodiments, however, require a significant expenditure of time and money to develop. Moreover, customized software solutions are generally not extensible to the data infrastructure of another corporation and must therefore be developed individually for each corporation.

According to the forgoing, various embodiments provide an automated system for detecting exceptions to normal business processes in real time and performing a configurable action following detection. Various exemplary embodiments detect exceptions in real time as messages are received by including a platform that performs real time message inspection for multiple enterprise services. One such platform is the Web Services Intranet Platform (WSIP). In various exemplary embodiments, the WSIP is a network node that is positioned in a corporation's data center and processes web service messages at run time in order to facilitate integration between corporations and to provide application level security and auditing.

Various exemplary embodiments add multiple components to a WSIP. Various exemplary embodiments include one or more of a scripting engine for expressing business process rules, a real time exception detection engine for exposing messages that violate the process rules, and secure storage for policies and exception logs.

Because all Simple Object Access Protocol (SOAP) requests and responses go through the WSIP, various exemplary embodiments employ the WSIP as a gatekeeper to services that are published both internally and externally. In such embodiments, the change management and audit integrity feature allows the WSIP to act according to stored policies.

In some embodiments, the WSIP acts as a client to web services, inquiring on states of certain records. Based on the state of the web service and the action requested via a SOAP request, the WSIP has the unique advantage in various exemplary embodiments of deciding if the SOAP request merits a process exception, thereby providing a runtime exception handling feature.

In various exemplary embodiments, the detection exception system and methods are implemented on a Web Services Gateway (WSG). In various exemplary embodiments, the WSG is a middleware component that provides an intermediary framework between Internet and intranet environments during Web service invocations. Thus, in various exemplary embodiments, the WSG runs on the same platform as the WSIP, but is located in a different position.

Various exemplary embodiments are a system for service access exception tracking, including one or more of the following: an exception detection engine that receives a web services request message associated with at least one web service; and a controller that sends a script to the exception detection engine, the script including a set of rules for the at least one web service.

In various exemplary embodiments, the exception detection engine detects at least one exception in the web services request message by applying the set of rules. In various exemplary embodiments, the exception detection engine drops the web services request message.

In various exemplary embodiments, the web services request message is a SOAP message. In various exemplary embodiments, the script is implemented in BPEL4WS.

In various exemplary embodiments, the system for web service access exception tracking includes a script storage database that stores script files. In various exemplary embodiments, the script storage database stores at least one exception descriptor, at least one exception handler, and at least one scripting language record.

In various exemplary embodiments, the exception detection engine is a runtime, multithreaded engine. In various exemplary embodiments, the exception detection engine reports the at least one detected exception to an auditing system. In various exemplary embodiments, the exception detection engine reports the at least one detected exception to an alarm system when a threshold is exceeded. In various exemplary embodiments, the system for web service access exception tracking includes an exceptions database that stores data regarding the at least one detected exception.

Various exemplary embodiments are a method of implementing a control path for a controller in a system for web service access exception tracking including one or more of the following: downloading a script, the script including a set of rules for at least one web service; sending the script to an exception detection engine; detecting at least one exception type with the exception detection engine by applying the set of rules to a web services request message; receiving the at least one exception type from the exception detection engine; and storing the at least one exception type in an exceptions database.

Various exemplary embodiments include downloading, from a policy database, at least one auditing requirement regarding the at least one web service. In various exemplary embodiments, the method of implementing a control path for a controller in a system for web service access exception tracking includes sending at least one exception handler to the exception detection engine.

Various exemplary embodiments are a method of detecting web service access exceptions including one or more of the following: receiving a web services request message, the web services request message associated with at least one web service; executing a script, the script including a set of rules for the at least one web service; detecting at least one exception in the web services request message by applying the set of rules to the web services request message; and dropping the web services request message.

Various exemplary embodiments include determining whether the at least one web service has an exception auditing requirement by querying a policy database. Various exemplary embodiments include reporting the at least one exception to an auditing system. Various exemplary embodiments include reporting the at least one exception to an alarm system when the at least one exception exceeds a predetermined threshold.

### BRIEF DESCRIPTION OF THE DRAWINGS

In order to better understand various exemplary embodiments, reference is made to the accompanying drawings, wherein:

FIG. 1 is a schematic diagram of a first exemplary embodiment of a system for service access exception tracking;

FIG. 2 is a flow chart of an exemplary embodiment of a method of implementing a control path for an exemplary Change Management and Audit Integrity Controller;

FIG. 3 is a flow chart of an exemplary embodiment of a method of real time business process exception detection and alarming;

FIG. 4 is a schematic diagram of a second exemplary embodiment of a system for service access exception tracking;

FIG. 5 is a schematic diagram of an exemplary embodiment of a Change Management and Audit Integrity Controller; and

FIG. 6 is a schematic diagram of an exemplary embodiment of a Process Exception Detection Engine.

### DETAILED DESCRIPTION OF THE PREFERRED EMBODIMENTS OF THE INVENTION

Referring now to the drawings, in which like numerals refer to like components or steps, there are disclosed broad aspects of various exemplary embodiments.

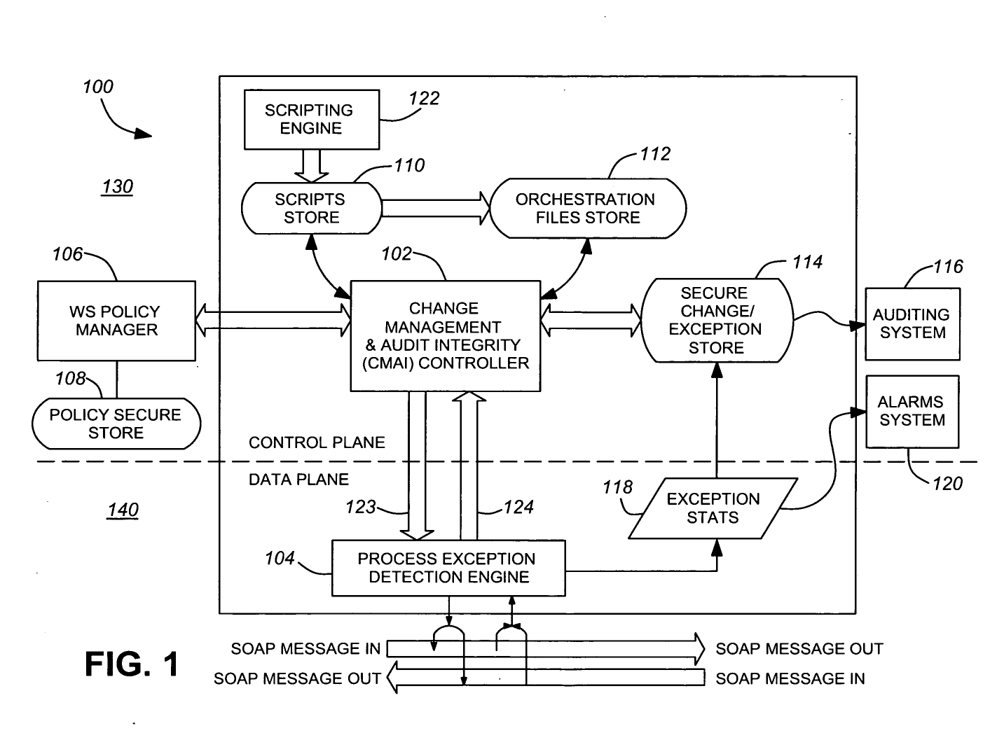

FIG. 1 is a schematic diagram of an exemplary embodiment of a system 100 for service access exception tracking. Exemplary Exception Tracking System 100 includes various combinations of dedicated software components executing on a real time web services message inspection platform, such as the WSIP. Exemplary Exception Tracking System 100 includes a Control Plane 130, which includes Change Management and Audit Integrity (CMAI) Controller 102, a WS Policy Manager 106, a Policy Secure Store 108, a Scripts Store 110, an Orchestration Files Store 112, a Secure Change/Exception Store 114, an Auditing System 116, an Alarms System 120, and a Scripting Engine 122. Exemplary Exception Tracking System 100 further includes a Data Plane 140, which includes a Process Exception Detection (PED) Engine 104 and Exception Stats 118.

The CMAI Controller 102 is the main architectural component for the control path of Exemplary Exception Tracking System 100. In various exemplary embodiments, CMAI Controller 102 communicates with the PED Engine 104 to send information about business processes, their script files and associated exception handlers, as indicated by arrow 123, and to receive exceptions encountered in the data path, as indicated by arrow 124. CMAI Controller 102 communicates with the WS Policy Manager 106 to gather information about all web services for which exception auditing is required. In various exemplary embodiments, these WS Policies are located in the Policy Secure Store 108.

CMAI Controller 102 of Exemplary Exception Tracking System 100 manages and coordinates the Scripts Store 110 and downloads script files from the Scripts Store 110. The scripting language used may be based on the Business Process Execution Language for Web Services (BPEL4WS) with extensions for handling mechanisms. In various exemplary embodiments, the scripting language includes fault and compensation handlers to detect exceptions and perform a corresponding action immediately.

In various exemplary embodiments, the script files include rules that specify process anomalies to be detected. Thus, in various exemplary embodiments, the script file specifies rules to prevent a single customer order from being entered more than once into the corporation's financial systems. Accordingly, in various exemplary embodiments, the script file could specify a particular order in which actions must be performed, thereby enabling Exemplary Exception Tracking System 100 to detect exceptions based on a user performing actions in an incorrect order. Thus, it should be apparent that Exemplary Exception Tracking System 100 may detect exceptions that occur even when the user is properly authenticated to access a particular web service.

CMAI Controller 102 of Exemplary Exception Tracking System 100 manages and coordinates the Orchestration Files Store 112 and downloads orchestration files from Orchestration Files Store 112.

PED Engine 104 is the main architectural component for the data path of Exemplary Exception Tracking System 100. In various exemplary embodiments, the PED Engine 104 is implemented as a runtime multithreaded engine. PED Engine 104 performs one or more of processing incoming and outgoing SOAP messages, identifying business processes, detecting business process exceptions, and executing exception handling.

PED Engine 104 of Exemplary Exception Tracking System 100 communicates with CMAI Controller 102 to obtain the business processes and their exception handlers, and to communicate the exception types encountered back to CMAI Controller 102. PED Engine 104 communicates with Secure Change/Exception Store 114 to store all counters and/or communicates with Auditing System 116 and Alarms System 120 to report events related to handling of exceptions. In various exemplary embodiments, PED Engine 104 only reports an exception to the Alarms System 120 when a threshold number of exceptions have occurred.

Exemplary Exception Tracking System 100 includes a Scripting Engine 122. Scripting Engine 122 helps model the business tasks and their exception handling management and contains the execution logic required for writing language scripts.

In various exemplary embodiments, Scripting Engine 122 communicates with Scripts Store 110 to save modeling results. Scripts Store 110 contains all exception descriptors, exception handlers, and the scripting language records necessary for the business processes.

Secure Change/Exception Store 114 is a database that contains the exception types received from the CMAI Controller 102 and the exception stats 118 received from the PED Engine 104. Orchestration Files Store 114 stores the orchestrations created by the designers of the multiple business processes.

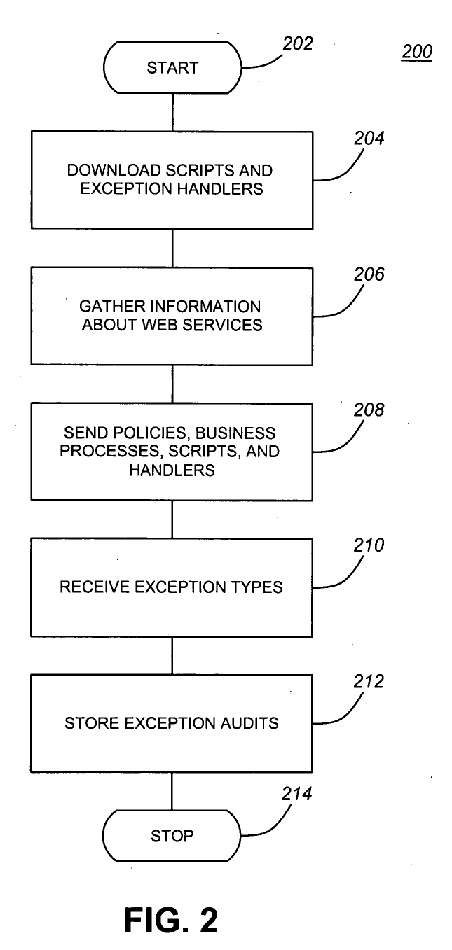

FIG. 2 is a flow chart of an exemplary embodiment of a method 200 of implementing a control path for an exemplary CMAI Controller 102. Exemplary method 200 starts in step 202 and proceeds to step 204, where CMAI Controller 102 downloads script files and associated exception handlers from Scripts Store 110. Exemplary method 200 then proceeds to step 206, where CMAI Controller 102 accesses Policy Secure Store 108 to gather information about all web services whose policies contain an auditing requirement. Exemplary method 200 then proceeds to step 208.

In step 208, CMAI Controller 102 sends the policies, business processes, scripts, and exceptions handlers to PED Engine 104. In various exemplary embodiments, PED Engine 104 performs real time business process exception detecting and alarming as described further herein. Exemplary method 200 then proceeds to step 210.

In step 210 of exemplary method 200, CMAI Controller 102 receives the detected exception types from PED Engine 104. After receiving the exception types, CMAI Controller 102 stores exception audits in the Secure Change/Exception Store 114 in step 212. Exemplary method 200 then proceeds to step 214, where exemplary method 200 stops.

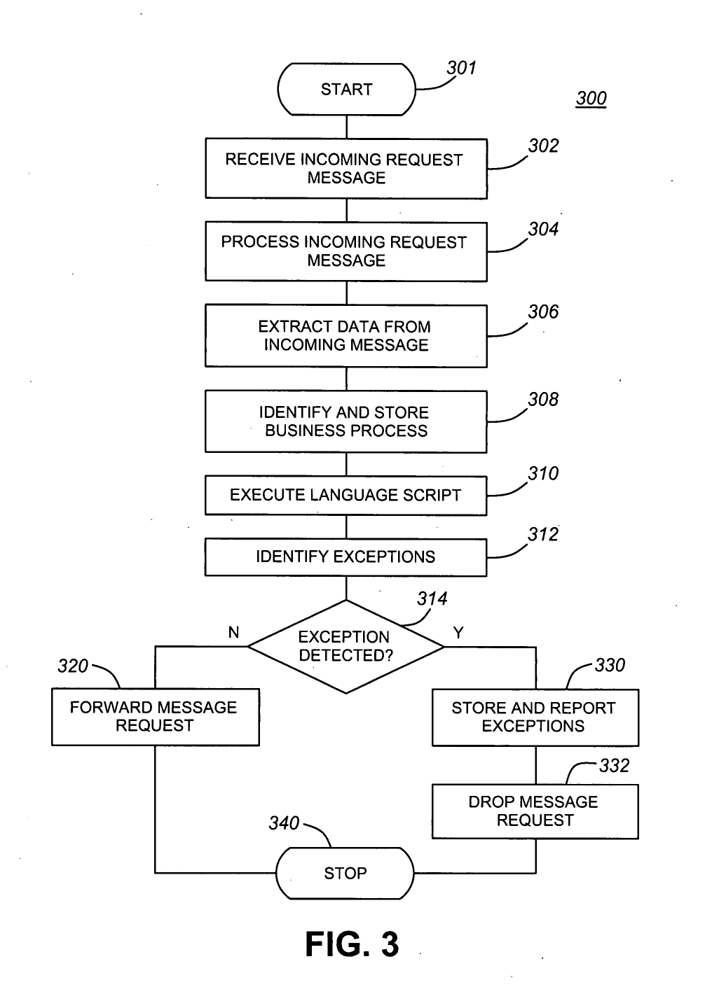

FIG. 3 is a flow chart of an exemplary embodiment of a method 300 of real time business process exception detection and alarming. Exemplary method 300 starts in step 301 and then proceeds to step 302, where the method 300 receives an incoming web service request message associated with at least one web service. This is a SOAP request in various exemplary embodiments. Exemplary method 300 then proceeds to step 304, where the method 300 processes the incoming request message. In various exemplary embodiments, PED Engine 104 determines in step 304 whether the current web service has a policy that contains an exception auditing requirement.

Following step 304, exemplary method 300 proceeds to step 306. In various exemplary embodiments, PED Engine 104 determines in step 306 which data to extract from the incoming message.

After extracting the data, exemplary method 300 proceeds to step 308, where, in various exemplary embodiments, PED Engine 104 communicates with CMAI Controller 102 to identify the current business process and obtain exception handlers for the process. Exemplary method 300 then proceeds to step 310, where, in various exemplary embodiments, PED Engine 104 interprets and executes the language script that is identified as a characteristic of the current business process instance.

In various exemplary embodiments, after interpreting and executing the language script, exemplary method 300 proceeds to step 312 where PED Engine 104 identifies exceptions by applying the rules defined in the script to the extracted data. When PED Engine 104 detects an exception in step 314, exemplary method 300 proceeds to step 330, where PED Engine 104 transfers the exception audits to the Secure Change/Exception Store 114 for storage. Exemplary method 300 then proceeds to step 332, where PED Engine 104 drops the SOAP message request. After dropping the message, exemplary method 300 proceeds to step 340, where the method 300 stops.

In various exemplary embodiments, when PED Engine 104 does not detect an exception in step 314, method 300 proceeds to step 320, where PED Engine 104 forwards the SOAP message request for execution. After forwarding the message, exemplary method 300 proceeds to step 340, where the method 300 stops.

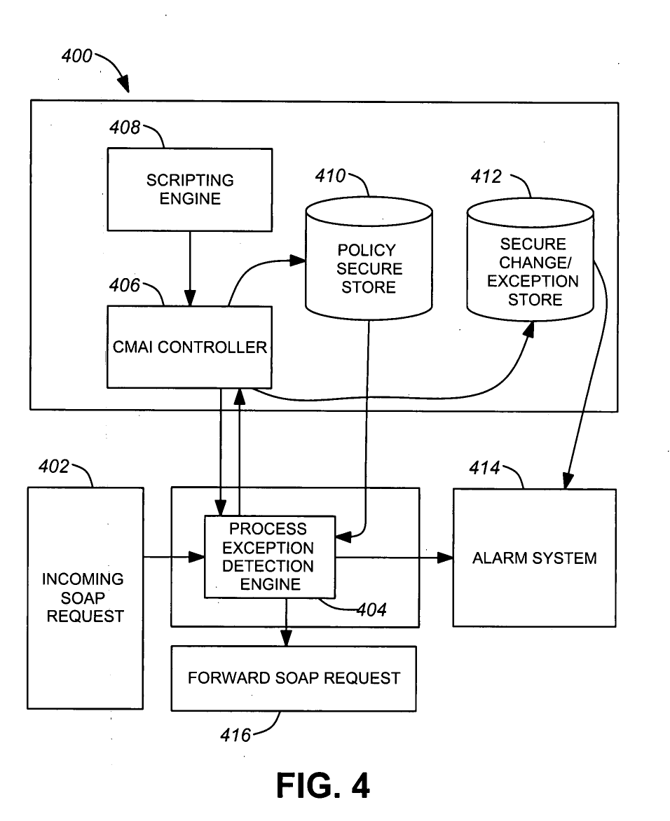

FIG. 4 is a schematic diagram of a second exemplary embodiment of a system 400 for service access exception tracking. Exemplary Exception Tracking System 400 includes an Incoming SOAP Request 402, a Process Exception Detection Engine 404, a CMAI Controller 406, a Scripting Engine 408, a Policy Secure Store 410, a Secure Change/Exception Store 412, an Alarm System 414, and a Forwarded SOAP Request 416.

Incoming SOAP Request 402 is a web services request message in SOAP format. The components of Exemplary Exception Tracking System 400 interact to process Incoming SOAP Request 402 to detect and report exceptions.

After receiving Incoming SOAP Request 402, PED Engine 404 determines whether the current web service has a policy that contains an exception auditing requirement. PED Engine 404 communicates with CMAI Controller 406 to obtain the business processes and their exception handlers. In various exemplary embodiments, PED Engine 404 extracts data from Incoming SOAP Request 402, interprets and executes a script received from CMAI Controller 406, and identifies exceptions by applying the rules defined in the script to the extracted data. When PED Engine 404 detects one or more exceptions in Incoming SOAP Request 402, PED Engine 404 drops Incoming SOAP Request 402 and forwards the exceptions to CMAI Controller 406, which in turn forwards the exceptions to Secure Change/Exception Store 412.

CMAI Controller 406 of Exemplary Exception Tracking System 400 communicates with PED Engine 404 to send information 122 about business processes, their script files and associated exception handlers, and to receive exceptions types 124 encountered in the data path. In various exemplary embodiments, CMAI Controller 406 gathers information about web services for which exception auditing is required from Policy Secure Store 410.

Exemplary Exception Tracking System 400 includes a Scripting Engine 408. Scripting Engine 408 helps model the business tasks and their exception handling management and contains the execution logic required for writing language scripts. In various exemplary embodiments, Scripting Engine 408 sends script files to CMAI Controller 406.

Policy Secure Store 410 of Exemplary Tracking System 400 maintains policy information for web services, including information about which web services require exception auditing. Policy Secure Store 410 sends policy information to CMAI Controller 406.

Secure Change/Exception Store 412 of Exemplary Exception Tracking System 400 is a database that contains exception types received from CMAI Controller 406.

Alarm System 414 of Exemplary Exception Tracking System 400 generates a notification when PED Engine 404 detects an exception. In various exemplary embodiments, Alarm System 414 only reports an exception to the Alarm System 414 when a threshold number of exceptions have occurred.

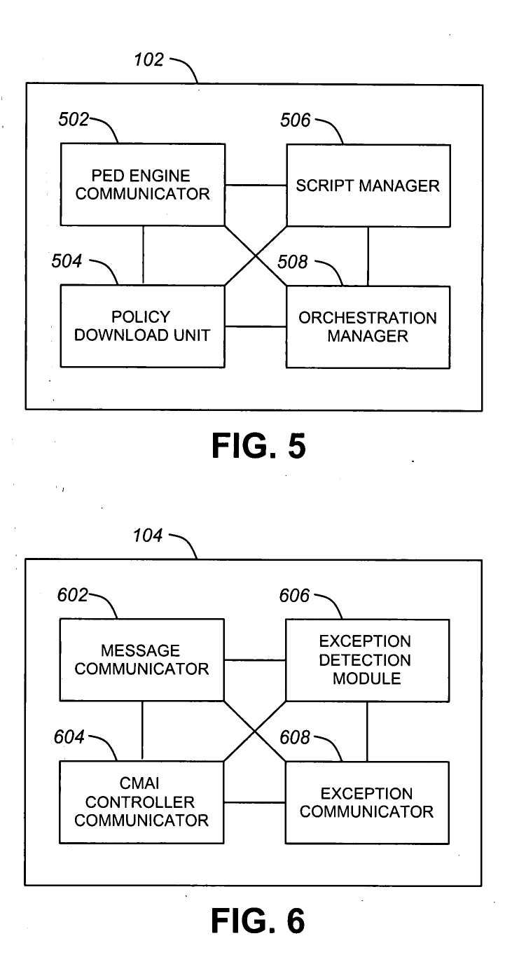

FIG. 5 is a schematic diagram of an exemplary embodiment of a Change Management and Audit Integrity Controller 102. Exemplary CMAI Controller 102 includes a PED Engine Communicator 502, a Policy Download Unit 504, a Script Manager 506, and an Orchestration Manager 508. It should be apparent that, in various exemplary embodiments, PED Engine Communicator 502, Policy Download Unit 504, Script Manager 506, and Orchestration Manager 508 are in communication with each other. In various exemplary embodiments, CMAI Controller 406 similarly includes one or more of PED Engine Communicator 502, Policy Download Unit 504, Script Manager 506, and Orchestration Manager 508 according to the description of that subject matter herein in connection with CMAI Controller 102.

PED Engine Communicator 502 of Exemplary CMAI Controller 102 manages exchange of data between CMAI Controller 102 and PED Engine 104. PED Engine Communicator 502 sends information about business processes, script files, and exception handlers to PED Engine 104. PED Engine Communicator 502 receives information regarding exception types detected in the data path by PED Engine 104.

Policy Download Unit 504 of Exemplary CMAI Controller 102 downloads information about web services that require exception auditing by communicating with WS Policy Manager 106. WS Policy Manager 106 retrieves the WS Policies from Policy Secure Store 108 and sends the policies to the Policy Download Unit 504 of CMAI Controller 102.

Script Manager 506 of Exemplary CMAI Controller 102 manages and coordinates the Scripts Store 110 and downloads script files from the Scripts Store 110. Orchestration Manager 508 of Exemplary CMAI Controller 102 manages and coordinates the Orchestration Files Store 112 and downloads orchestration files from Orchestration Files Store 112.

When PED Engine 404 does not detect any exceptions in Incoming SOAP Request 402, PED Engine 404 outputs Forwarded SOAP Request 416.

FIG. 6 is a schematic diagram of an exemplary embodiment of a Process Exception Detection Engine 104. Exemplary PED Engine 104 includes a Message Communicator 602, a CMAI Controller Communicator 604, an Exception Detection Module 606, and an Exception Communicator 608. It should be apparent that, in various exemplary embodiments, Message Communicator 602, CMAI Controller Communicator 604, Exception Detection Module 606, and Exception Communicator 608 are in communication with each other. In various exemplary embodiments, PED Engine 404 similarly includes one or more of Message Communicator 602, CMAI Controller 604, Exception Detection Module 606, and Exception Communicator 608 according to the description of that subject matter herein in connection with Process Exception Detection Engine 104.

Message Communicator 602 of Exemplary PED Engine 104 receives incoming and outgoing web services request messages. In various exemplary embodiments, these web services request messages are SOAP requests.

CMAI Controller Communicator 604 of Exemplary PED Engine 104 downloads information about business processes, script files, and exception handlers from CMAI Controller 102. CMAI Controller Communicator 604 sends information regarding exception types detected in the data path by PED Engine 104.

Exception Detection Module 606 of Exemplary PED Engine 104 implements the exception detection process. In various exemplary embodiments, Exception Detection Module 606 applies the set of rules in the script file downloaded by CMAI Controller Communicator 604 to the web services request message received by Message Communicator 602. When Exception Detection Module 606 detects one or more exceptions in the web services request message, Exception Detection Module 606 drops the message. When Exception Detection Module 606 does not detect any exceptions in the Exception Detection Module 606 returns the message to Message Communicator 602, which sends the message for execution.

Exception Communicator 608 of Exemplary PED Engine 104 sends information regarding exceptions detected by Exception Detection Module 606 to Secure Change/Exception Store 114. Exception Communicator 608 communicates with Auditing System 116 and Alarms System 120 to report events related to exceptions handling. In various exemplary embodiments, Exception Communicator 608 only reports an exception to the Alarms System 120 when a threshold number of exceptions have occurred.

Although the various exemplary embodiments have been described in detail with particular reference to certain exemplary aspects thereof, it should be understood that the invention is capable of other different embodiments, and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only, and do not in any way limit the invention, which is defined only by the claims.

What is claimed is:

1. A system for service access exception tracking, comprising:
an exception detection engine that receives a web services request message, the web services request message associated with at least one web service; and
a controller that sends a script to the exception detection engine, the script comprising a set of rules for the at least one web service, wherein
the exception detection engine detects at least one exception in the web services request message by applying the set of rules, and
the exception detection engine drops the web services request message.

2. The system for web service access exception tracking according to claim 1, wherein the web services request message is a SOAP message.

3. The system for web service access exception tracking according to claim 1, wherein the script is implemented in BPEL4WS.

4. The system for web service access exception tracking according to claim 1, further comprising a script storage database that stores script files.

5. The system for web service access exception tracking according to claim 4, wherein the script storage database stores at least one exception descriptor, at least one exception handler, and at least one scripting language record.

6. The system for web service access exception tracking according to claim 1, wherein the exception detection engine is a runtime, multi-threaded engine.

7. The system for web service access exception tracking according to claim 1, wherein the exception detection engine reports the at least one detected exception to an auditing system.

8. The system for web service access exception tracking according to claim 1, wherein the exception detection engine reports the at least one detected exception to an alarm system when a threshold is exceeded.

9. The system for web service access exception tracking according to claim 1, further comprising an exceptions database that stores data regarding the at least one detected exception.

10. A method of implementing a control path for a controller in a system for web service access exception tracking, comprising:
downloading a script, the script comprising a set of rules for at least one web service;
sending the script to an exception detection engine;
detecting at least one exception type with the exception detection engine by applying the set of rules to a web services request message;
receiving the at least one exception type from the exception detection engine; and
storing the at least one exception type in an exceptions database.

11. The method of implementing a control path according to claim 10, wherein the web services request message is a SOAP message.

12. The method of implementing a control path according to claim 10, wherein the script is implemented in BPEL4WS.

13. The method of implementing a control path according to claim 10, further comprising downloading, from a policy database, at least one auditing requirement regarding the at least one web service.

14. The method of implementing a control path according to claim 10, wherein sending the script to an exception detection engine further comprises sending at least one exception handler to the exception detection engine.

15. A method of detecting web service access exceptions, comprising:
receiving a web services request message, the web services request message associated with at least one web service;
executing a script, the script comprising a set of rules for the at least one web service;
detecting at least one exception in the web services request message by applying the set of rules to the web services request message; and
dropping the web services request message.

16. The method of detecting web service access exceptions according to claim 15, wherein the web services request message is a SOAP message.

17. The method of detecting web service access exceptions according to claim 15, wherein the script is implemented in BPEL4WS.

18. The method of detecting web service access exceptions according to claim 15, further comprising determining whether the at least one web service has an exception auditing requirement by querying a policy database.

19. The method of detecting web service access exceptions according to claim 15, further comprising reporting the at least one exception to an auditing system.

20. The method of detecting web service access exceptions according to claim 15, further comprising reporting the at least one exception to an alarm system when the at least one exception exceeds a predetermined threshold.
